(19) United States
(12) Patent Application Publication
(10) Pub. No.: US 2004/0214020 A1
(43) Pub. Date: Oct. 28, 2004

(54) Covering shell and a method of manufacturing such a shell

(76) Inventor: Sylvie Lecomte, Apremont (FR)

Correspondence Address: Marina F. Cunningham, McCormick, Paulding & Huber LLP, CityPlace II, 185 Asylum Street, Hartford, CT, 06103, US

(21) Appl. No.: 10/457,650

(22) Filed: Jun. 9, 2003

(30) Foreign Application Priority Data
Apr. 28, 2003 (FR) 0305151

(51) Int. Cl. B32B 3/00

(52) U.S. Cl. 428/457; 428/156; 428/15

(57) ABSTRACT

The present invention relates to a covering shell comprising a shell body which is made of a transparent material. The shell body has faceting on a concave inside surface and/or on a convex outside surface, the concave inside surface further being coated with a reflective layer that generates multiple reflections when the convex outside surface is illuminated. The invention also relates to a method of manufacturing such a covering shell by molding.

### FIELD OF THE INVENTION

The present invention relates to the field of covering shells, and in particular to shells designed to impart a decorative appearance essentially based on optical effects as a function of the way the outside of the shell is illuminated.

### BACKGROUND OF THE INVENTION

Covering shells are known that are designed to constitute protective coverings and whose inside and outside surfaces are smooth. Use is then made of a conventional technique whereby a plastics material is injected into the space defined by complementary male and female mold cavities. When a particular decorative shell effect is desired, a decorative pattern is generally applied to the inside face of the injection-molded shell, either by transfer from a strip decorated with a detachable pattern, or by decoration directly on the inside surface, the shell body then being made of a transparent material so as to enable the decorative pattern to be seen from the outside. This is how covers having various types of fancy decorative patterns are commonly proposed for cellphones.

Another field of use for covering shells is the field of false nails. In this field too, injection molding techniques are used, as are complementary male and female mold cavities having smooth surfaces. After injection molding, a covering shell is thus obtained that has smooth faces and that can be bonded with adhesive to the natural fingernail in order to perform its function, either for therapeutic purposes, or for more fanciful purposes for procuring a decorative element enhancing the appearance of the hand.

Generally, none of the shells commonly made, in particular in the two above-mentioned fields of use, have structures organized to produce particular effects of the optical or holographic type.

### OBJECT OF THE INVENTION

An object of the invention is to provide a covering shell whose structure makes it possible precisely to generate optical or analogous effects, e.g. holographic effects, as a function of the way the outside of the shell is illuminated, so as to impart a particular appearance that is pleasing to the eye.

An object of the invention is also to provide a method of manufacturing such a covering shell that can be adapted to accommodate a very wide variety of shell structure parameters as a function of the desired optical effects.

### GENERAL DEFINITION OF THE INVENTION

The above-mentioned technical problem is solved by the invention by means of a covering shell which is remarkable in that it comprises a shell body which is made of a transparent material and which has faceting on a concave inside surface and/or on a convex outside surface, the concave inside surface further being coated with a reflective layer that generates multiple reflections when the convex outside surface is illuminated.

Thus, the above-mentioned faceting, which may be of a very wide variety of types as a function of the geometrical shapes and of the optical effects that are desired, makes it possible to obtain sparkle effects that vary as a function of the angles of incidence of the rays that illuminate the outside of the covering shell. It is then possible to obtain a whole series of optical or holographic effects imparting a particular decorative appearance, in particular reminiscent of the effects encountered with cut gemstones, regardless of the type of use for which the covering shell is designed. In particular, in the two above-mentioned fields of application which are those of false nails and of covering shells for cellphones, results are obtained that procure very original appearance, with a very attractive “jewel” effect.

It is possible to make provision for the convex outside surface to be faceted, while the concave inside surface is essentially smooth, or conversely for the concave inside surface to be faceted, while the convex outside surface is essentially smooth.

In a variant, provision may be made for both the convex outside surface and the concave inside surface to be faceted. In particular, the faceting on the two surfaces may be generally in register, or else slightly offset laterally.

Provision may also be made for the faceting on the concave inside surface and/or on the convex outside surface to be uniformly rectilinear or curvilinear, or, in a variant, to be of the prismatic type like the way in which gemstones are cut.

In a particular embodiment that may also be envisaged, the concave inside surface is a separate element constituted by a thin under-shell which is secured to the shell body. In particular, the under-shell is made of a precious metal, e.g. gold.

The reflective layer may be constituted by a mirror film or by a strip of optical fibers adhering intimately to the concave inside surface, or, in a variant, it may be constituted by being deposited on the concave inside surface, in particular by metallization using vapor deposition or sputtering.

Preferably, the transparent material of which the shell body is made is chosen from the group comprising inorganic or plastics materials (colored or otherwise) such as acrylonitrile butadiene styrene (ABS) or polymethyl methacrylate (PMMA).

In a particular embodiment, which is in no way limiting on the ambit of the invention, the covering shell constitutes an artificial fingernail, or else trim for electrical or electronic equipment, in particular for a cellphone.

The invention also provides a method of manufacturing a covering shell having at least one of the above-mentioned characteristics.

The manufacturing method of the invention consists in using a mold made up of one half-mold having a convex molding shape and of one half-mold having a complementary concave molding shape, the convex molding shape and/or the concave molding shape having surface faceting, and in coating the concave inside surface of the shell body molded between the two mold cavities with a reflective layer.

Provision may be made for the reflective coating to be formed in situ during molding, by inserting a mirror film between the two mold cavities before the mold is closed, the point of injection then being provided in the half-mold that has a concave molding shape.

In a variant, the reflective coating may be formed after molding by being deposited, in particular by metallization using vapor deposition or sputtering, on the concave inside surface of the shell body as molded, after the mold has been opened.

Other characteristics and advantages of the invention appear more clearly on reading the following description with reference to the accompanying drawings concerning particular embodiments.

### DESCRIPTION OF THE DRAWINGS

Reference is made to the figures of the accompanying drawings, in which:

FIG. 1 is a perspective view of a covering shell of the invention, which shell is, in this example, designed to constitute an artificial fingernail, and has its inside and outside faces faceted with curvilinear-type faceting;

FIG. 2 shows a cross-section on II-IT of FIG. 1;

FIG. 3 shows a variant in which the covering shell has faceting on its convex outside surface only, and

FIG. 4 shows an associated cross-section on line IV-IV of FIG. 3;

FIG. 5 shows another variant in which the faceting is provided on the concave inside surface only, and

FIG. 6 shows a corresponding cross-section on line VI-VI of FIG. 5;

FIG. 7 shows yet another variant whose inside and outside surfaces are faceted, with rectilinear-type faceting, and

FIG. 8 shows a corresponding cross-section on line VIII-VIII of FIG. 7;

FIG. 9 shows another type of faceting which is prismatic like the way in which gemstones are cut, said faceting being provided on both the inside and the outside faces in this example, and

FIG. 10 shows a corresponding cross-section on line X-X of FIG. 9;

FIG. 11 shows yet another variant in which the concave inside surface is a separate piece constituted by a thin under-shell which, in this example, is crimped on, and

FIG. 12 shows a corresponding cross-section on line XII-XII of FIG. 11;

FIG. 13 shows a particular use in which the covering shell of the invention constitutes an artificial fingernail;

FIG. 14 shows another use in which the covering shell constitutes trim for a cellphone;

FIG. 15 is a perspective view showing a method of manufacturing a covering shell of the above-mentioned type by molding;

FIG. 16 diagrammatically shows the manufacturing method in which the reflective coating is formed in situ during molding by inserting a mirror film before the mold is closed; and

FIG. 17 shows a variant of the above-mentioned method, in which the reflective coating is formed after molding, by being deposited directly on the concave inside surface of the body of the molded shell.

### DETAILED DESCRIPTION OF PREFERRED EMBODIMENTS

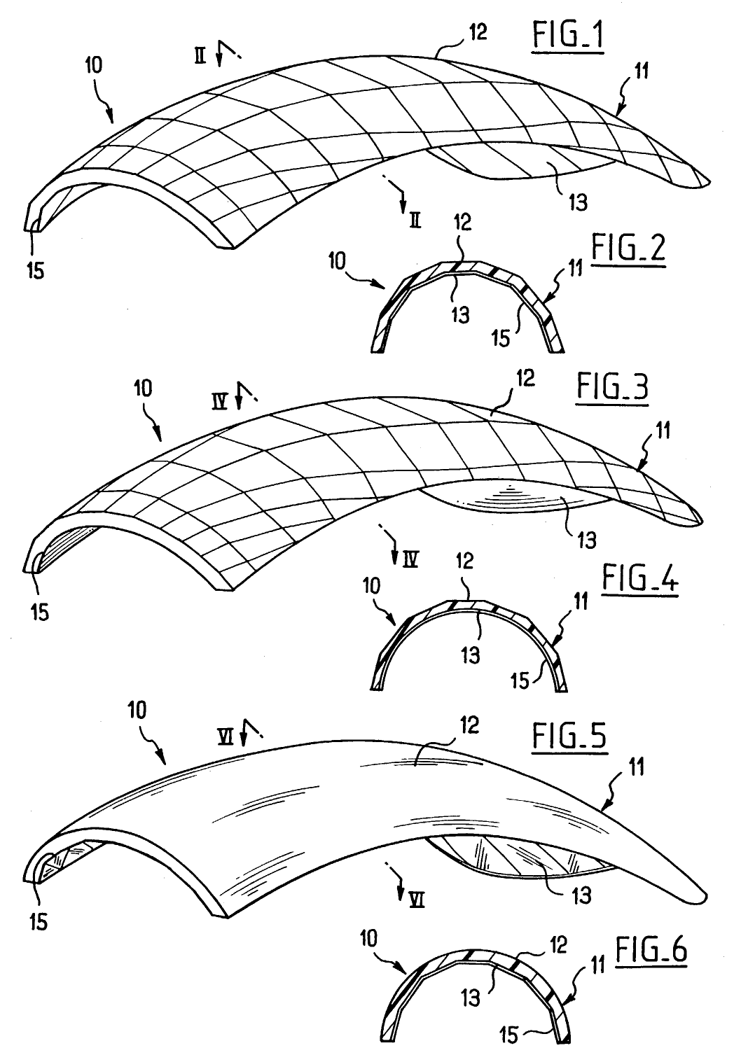

FIGS. 1 to 12 show various embodiments of a covering shell 10 of the invention.

In general, the covering shell 10 comprises a shell body 11 made of a transparent material, having faceting on a concave inside surface 13 and/or on a convex outside surface 12. In addition, the concave inside surface 13 is coated with a reflective layer 15 that generates multiple reflections when the convex outside surface 12 is illuminated.

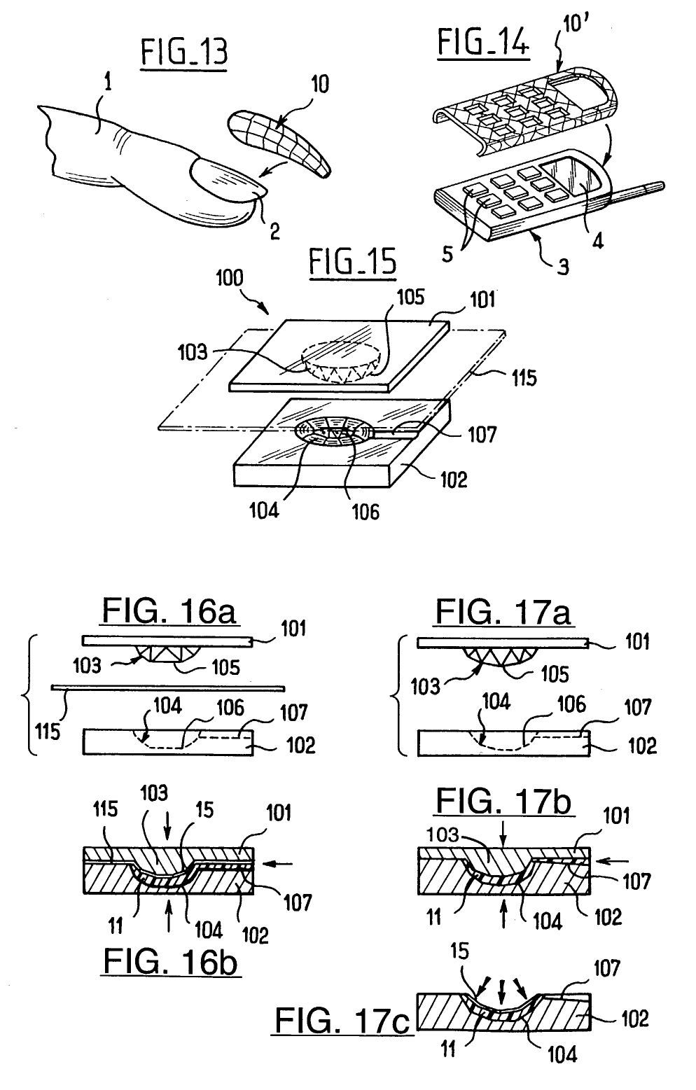

In FIGS. 1 to 12, the covering shell 10 is designed to constitute an artificial fingernail, as shown diagrammatically in FIG. 13. FIG. 13 shows the end of a finger having a natural fingernail 2 which can be covered by a covering shell 10 of the invention that constitutes an artificial fingernail. The covering shell 10 is then bonded to the natural fingernail 2 using a suitable adhesive of the type conventionally used in the field of false nails.

By way of example, another variant may be mentioned in which the covering shell is designed to constitute trim for electrical or electronic equipment. FIG. 14 shows such a shell, referenced 10′, which is designed to form trim for a cellphone 3, of which the display screen 4 and the key pad 5 can be seen.

Naturally, it is possible to consider many other fields of use for the invention, whenever some decorative and attractive effect is desired. The description returns below to the precise structure of such covering shells formed in accordance with the invention.

In FIGS. 1 and 2, the covering shell comprises a shell body 11 made of a transparent material, and having a convex outside surface 12 and a concave inside surface 13, both of which are faceted. In this example, the faceting is curvilinear, i.e. the facets are formed of quadrilaterals whose sides are defined by progressively curved lines. The faceting on the two surfaces 12, 13 may be substantially in register, optionally with a small lateral offset if a particular optical effect generated by such an offset between the faceting is desired.

In FIGS. 3 and 4, the shell body 11 has a convex outside surface 12 which is faceted while the concave inside surface 13 is essentially smooth. Here too, the faceting on the outside surface is of the curvilinear type.

In FIGS. 5 and 6, the shell body 11 has a concave inside surface 13 which is faceted, while the convex outside surface 12 is essentially smooth. The faceting is also of the curvilinear type. In this case, it is possible to choose the component material and the thickness of the shell body to have a magnifying effect which further accentuates the optical effect generated by the faceting on the concave inside surface.

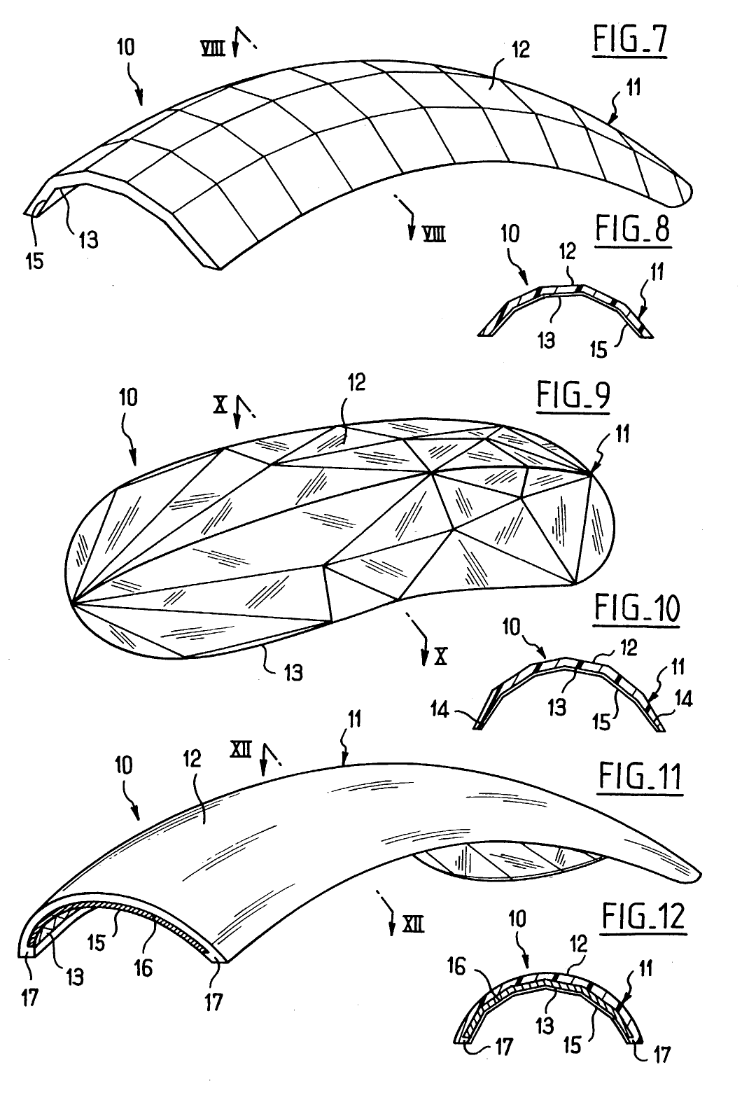

In FIGS. 7 and 8, the covering shell comprises a shell body 11 whose convex outside surface 12 and whose concave inside surface 13 are both faceted. However, the faceting is different in that it is of the rectilinear type, i.e. the facets are constituted by squares or rectangles whose sides are defined by essentially parallel lines.

In FIGS. 9 and 10, a shell body 11 is shown on which the faceting on the concave inside surface 13 and/or on the convex outside surface 12 is of the prismatic type, like the way gemstones are cut. In this case, the faceting is made up of facets that are essentially triangular or polygonal, like those that are to be found on the top portion or on the base of a cut gemstone, the facets being organized in compliance with geometrical relationships that are well known for cutting fine or fancy jewels, with angles chosen to procure multiple reflections generating the desired attractive effect. In addition, FIGS. 9 and 10 show the possibility of tapering the edges 14 of the resulting shell body.

In all of the above-described variants, the shell body 11 is made of a transparent material, and the concave inside surface of the shell 10 is merely the concave inside surface of the shell body 11. However, it is possible to consider adding another element to the shell body, so that the concave inside surface of the covering shell is constituted by the free surface of the added other element.

Such a variant is shown in FIGS. 11 and 12, and it can be observed on these figures that the concave inside surface 13 is a separate added element constituted by a thin under-shell 16 which is secured to the shell body 11. For example, the under-shell 16 is made of a precious metal, such as gold. Naturally, in practice such an under-shell is extremely thin, i.e. approximately in the range a few tenths of a millimeter to approximately one millimeter in the central portion. For example, the under-shell 16 may be crimped between associated lips 17 projecting from the bottom of the shell body 11 as shown. In a variant that is not shown herein, it is possible to make provision for the free edge of the under-shell 16 to have an upturned margin encasing the free edge of the shell body 11. External crimping is then obtained, further imparting an attractive appearance by allowing a flat margin analogous to a ring to appear. The under-shell 16 may also be secured to the shell body 11 by clipping, or bonding with or without an adhesive.

It is also possible to make provision to surround the covering shell having internal and/or external faceting with a peripheral bead (variant not shown) which may be made of a precious metal such as gold, in the manner of the outline of a ring.

As mentioned above, the concave inside surface 13 of the covering shell 10 is coated with a reflective layer that generates multiple reflections when the convex outside surface 12 of the covering shell is illuminated. FIGS. 1 to 12 thus make it possible to see such as reflective layer, which is referenced 15. The reflective layer 15 may be constituted by a mirror film adhering intimately to the concave inside surface 13, or, in a variant, it may be constituted by being deposited, in particular by metallization using vapor deposition or sputtering, or else by hot marking, irisation or pad printing, performed directly on the concave inside surface 13. When a mirror film is implemented, a strip is preferably used whose thickness lies approximately in the range a few microns to a few tenths of a millimeter, based on metal oxides or on a precious metal. It may be a film (plain or otherwise) that has particular optical effects (e.g. moire effects) or a film of the holographic type. In another variant, which is not shown herein, the mirror film may be replaced with a strip of optical fibers juxtaposed side-by-side. This is particularly advantageous for cellphone trim. When metallization is implemented, the thickness of the layer is, in general, approximately a few microns.

In general, the transparent material of which the shell body 11 is made is chosen from the group comprising inorganic or plastics materials (colored or otherwise) such as acrylonitrile butadiene styrene (ABS), polymethyl methacrylate (PMMA), or else synthetic materials sold under the trade names San, Surlyn, or Cristal. More generally, it is possible to use any materials such as thermo-settable synthetic resins, acrylic resins, natural materials of the amber type, having the desired transparence and shine characteristics, in particular from an optical and a mechanical standpoint.

A method of manufacturing such a covering shell of the invention is described below with reference to FIGS. 15 to 17 which diagrammatically show means for implementing such a manufacturing method by molding.

FIG. 15 shows an injection mold 100 constituted by a half-mold 101 having a convex molding shape 103 and by a half-mold 102 having a concave molding shape 104 that is complementary to the above-mentioned convex molding shape. The free surface of the convex molding shape 103 is referenced 105, while the free surface of the concave molding shape 104 is referenced 106. According to a characteristic of the invention, the convex molding shape 103 and/or the concave molding shape 104 have surface faceting on their free surfaces 105, 106; The surface faceting may be achieved by computer-controlled machining based on a digitized model. Naturally, a point of injection is provided for injecting the material into the mold, and in the example shown, said point of injection is constituted by a channel 107 provided in the half-mold 12 that has the concave molding shape 104.

FIG. 15 shows, in chain-dotted lines, the presence of a mirror film 115 which is inserted between the two mold cavities 103, 104 before the mold 100 is closed. As indicated above, the mirror film may be replaced by a strip of optical fibers.

This corresponds to the step a) of FIG. 16. The two half-molds 102, 104 are then brought together (step b)), and the material injection is organized simultaneously so that, in a single molding pass, the shell body 11 and the reflective coating 15 are formed in situ during molding by the corresponding portion of the film 115. The film 115 adheres directly to the convex molding shape 103, against which it is applied by the inorganic or plastics material that is injected (“in-mold film transfer” technique). Naturally, a component material is chosen for the mirror film that has characteristics suitable for enabling it to be applied intimately to a faceted surface, without incipient tears occurring in the resulting shaped film. In the event that a tear forms locally, an undesirable defect is obtained that interferes with the optical reflections that are generated, and therefore with the desired decorative effect.

In a variant, and as shown in FIG. 17, the reflective coating may be formed after molding, by deposition, in particular by metal-plating using vapor deposition or sputtering, performed directly on the concave inside surface 13 of the shell body 11 as molded, after the mold 100 has been opened. In FIG. 17, step a) corresponds to the mold being in the open state, without the mirror film 115 being present, then step b) corresponds to the step in which the material is injected into the space defined between the two complementary mold cavities 103, 104, while step c), which takes place after the mold has been opened to give access to the concave inside surface 13 of the shell body 11, corresponds to coating by metallization using vapor deposition or sputtering or the like (e.g. hot marking) on the free surface in order to constitute the desired layer of reflective coating 15.

Thus, it is possible to achieve a covering shell and a method of manufacturing it making it possible to obtain a multitude of shells having facets on the concave inside surfaces and/or on the convex outside surfaces of their shell bodies. The multiplicity of the variants described aims to make the reader fully aware of the large number of possibilities for making covering shells, each different shell configuration having specific optical effects inherent to the type of faceting chosen, by means of the multiple reflections that are generated when the convex outside surface of the covering shell is illuminated.

In particular, the invention has a very advantageous use in the field of false nails and of shells for covering electrical or electronic equipment, in particular cellphones. Naturally, other fields of use not mentioned herein may be considered, in which a facet-generated sparkle or shine effect is desired for procuring a particular attractive appearance.

The invention is not limited to the above-described embodiments, but rather it encompasses any variant using equivalent means to reproduce the above-mentioned essential characteristics.

What is claimed is:

1/ A covering shell, comprising a shell body which is made of a transparent material and which has faceting on a concave inside surface and/or on a convex outside surface, the concave inside surface further being coated with a reflective layer that generates multiple reflections when the convex outside surface is illuminated.

2/ A covering shell according to claim 1, wherein the convex outside surface is faceted, while the concave inside surface is essentially smooth.

3/ A covering shell according to claim 1, wherein the concave inside surface is faceted, while the convex outside surface is essentially smooth.

4/ A covering shell 1 according to claim 1, wherein both the convex outside surface and the concave inside surface are faceted.

5/ A covering shell according to claim 4, wherein the faceting on the two surfaces is generally in register.

6/ A covering shell according to claim 4, wherein the faceting on the two surface is slightly offset laterally.

7/ A covering shell according to claim 1, wherein the faceting on the concave inside surface and/or on the convex outside surface is uniformly rectilinear or curvilinear.

8/ A covering shell according to claim 1, wherein the faceting on the concave inside surface and/or on the convex outside surface is of the prismatic type like the way in which gemstones are cut.

9/ A covering shell according to claim 1, wherein the concave inside surface is a separate element constituted by a thin under-shell which is secured to the shell body.

10/ A covering shell according to claim 9, wherein the under-shell is made of a precious metal.

11/ A covering shell according to claim 1, wherein the reflective layer is constituted by a mirror film or by a strip of optical fibers adhering intimately to the concave inside surface.

12/ A covering shell according to claim 1, wherein the reflective layer is constituted by being deposited on the concave inside surface, in particular by metallization using vapor deposition or sputtering.

13/ A covering shell according to claim 1, wherein the transparent material of which the shell body is made is chosen from the group comprising inorganic or plastics materials (colored or otherwise) such as acrylonitrile butadiene styrene or polymethyl methacrylate.

14/ A covering shell according to claim 1, constituting an artificial fingernail.

15/ A covering shell according to claim 1, constituting trim for electrical or electronic equipment, in particular for a cellphone.

16/ A method of manufacturing a covering shell according to claim 1, the method consisting in using a mold made up of one half-mold having a convex molding shape and of one half-mold having a complementary concave molding shape, the convex molding shape and/or the concave molding shape having surface faceting, and in coating the concave inside surface of the shell body molded between the two mold cavities with a reflective layer.

17/ A method according to claim 16, wherein the reflective coating is formed in situ during molding, by inserting a mirror film between the two mold cavities before the mold is closed, the point of injection then being provided in the half-mold that has a concave molding shape.

18/ A method according to claim 16, wherein the reflective coating is formed after molding by being deposited, in particular by metallization using vapor deposition or sputtering, on the concave inside surface of the shell body as molded, after the mold has been opened.
